(19) United States
(12) Patent Application Publication
(10) Pub. No.: US 2013/0346180 A1
(43) Pub. Date: Dec. 26, 2013

(54) SYSTEMS AND METHODS FOR BENEFITS TRACKING AND ALLOCATION

(71) Applicant: Performance Loyalty Group Inc., San Ramon, CA (US)

(72) Inventors: JEFFREY SHENK, Danville, CA (US); MICHAEL GORUN, Alamo, CA (US); MITAL BHATT, San Ramon, CA (US)

(73) Assignee: Performance Loyalty Group Inc., San Ramon, CA (US)

(21) Appl. No.: 14/012,641

(22) Filed: Aug. 28, 2013

(51) Int. Cl. G06Q 30/02

(52) U.S. Cl. CPC G06Q 30/0233
USPC 705/14.33

(57) ABSTRACT

Methods and systems for benefits tracking and allocation are disclosed. One system includes a benefits server comprising a database including stored customer accounts associated with at least one member having at least one member server. The benefits server is configured to communicate with the at least one member server via a network, and retrieve customer transaction data from the at least one member server, the customer transaction data indicative of interactions between the at least one member and customers of the at least one member. The benefits server is further configured to extract customer information from the customer transaction data, search the database for the customer transaction data, and, when the customer information is found in the database, update a customer account in the database with the customer transaction.

### BACKGROUND

Businesses are constantly searching for methods to encourage repeat customers. In some cases, businesses utilize loyalty systems, such as promotional coupon books, discounts, punch cards, or the like, as forms of rewarding repeat customers. However, such methods are susceptible to fraud and can ultimately be more injurious to a business than beneficial. Furthermore, such existing promotional systems do not provide any convenient tracking operation to determine the effectiveness of such promotions.

Businesses have also used similar systems to encourage customers to pre-pay for goods or services. However, such pre-payment systems also have drawbacks, both for the customer and for the business. Customers who purchase goods and/or services using such pre-paid arrangements do not have a convenient mechanism for tracking the status of any pre-paid goods or services that they have purchased. Concurrently, businesses have limited ability to determine whether customers will redeem the remaining pre-paid goods or services; this makes it difficult for such businesses to determine an appropriate time at which the business can realize any profit from unredeemed pre-paid goods or services.

### SUMMARY

In one embodiment, a system is described that includes a benefits server comprising a database including stored customer accounts associated with at least one member. The benefits server is configured to communicate with at least one member server via a network, and retrieve customer transaction data from the at least one member server. The customer transaction data is indicative of interactions between the at least one member and customers of the at least one member. The benefits server is further configured to extract customer information from the customer transaction data, search the database for the customer transaction data, and, when the customer information is found in the database, update a customer account in the database with the customer transaction.

In another embodiment, a method includes retrieving a repair order from a first member, identifying customer information and member information associated with the repair order, determining whether the customer information matches a stored customer account, when there is a match, applying a stored algorithm associated with the first member to determine a benefits value; and adding the benefits value to the stored customer account.

These and various other features as well as advantages which characterize the systems and methods described herein will be apparent from a reading of the following detailed description and a review of the associated drawings. Additional features are set forth in the description which follows, and in part will be apparent from the description, or may be learned by practice of the technology. It is to be understood that both the foregoing general description and the following detailed description are exemplary and explanatory and are not intended to limit the scope of the various aspects disclosed herein.

### BRIEF DESCRIPTION OF THE DRAWINGS

FIG. 1 is a schematic diagram illustrating an exemplary benefits tracking system.

FIG. 2 is a schematic block diagram illustrating an exemplary architecture of a computing device for implementing aspects of the benefits tracking system shown in FIG. 1.

FIG. 3 is a schematic block diagram illustrating an exemplary architecture of a benefits tracking system.

FIG. 4 is a schematic block diagram illustrating an exemplary architecture of a database for implementing aspects of the benefits tracking system shown in FIG. 1.

FIG. 5 is a flow chart illustrating an exemplary method of benefits tracking and allocation.

FIG. 6 is a flow chart illustrating an exemplary method of benefits tracking and allocation.

FIG. 7 is a flow chart illustrating an exemplary method of operation of a benefits tracking system described herein.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments of the appended claims.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

In general, the present disclosure describes systems and methods of tracking and allocating vendor-tracked benefits, including both loyalty incentives and prepaid goods/services. Example systems include members, member customers, and a benefits tracking and allocating server(s). The benefits tracking and allocating server(s) acts as a third-party that tracks member customers' loyalty to associated members, and also tracks pre-payments for goods and services by member customers for each of the associated members. For example, the tracking and allocating server(s) stores accounts for member customers and tracks interactions between member customers and members. These interactions can include sales or services interactions, as well as communications from the member to its associated member customers.

Based on the general types of interactions, including, for example frequency and quality interactions and a set of predefined rules for each member, the benefits tracking and allocating server(s) allocates benefits (e.g., points, credits for prepayment, deals, etc.) to member customers. Benefits may be presented to members and member customers via an online website or physical documents. Member customers may redeem benefits with members.

The methods and systems of the present disclosure allow for improved automation and aggregation of benefit programs (e.g., loyalty or prepaid programs) that would otherwise be required to be administered individually by members (e.g., auto dealers), and which are not readily automated. This includes both administration of such benefit programs, as well as automation of communications with member customers to promote sales. Accordingly, the methods and systems of the present disclosure allow for offloading of such benefits (e.g. product incentive, loyalty, or prepayment) systems from members themselves, without incurring substantial non-automated (manual) processing at a central server.

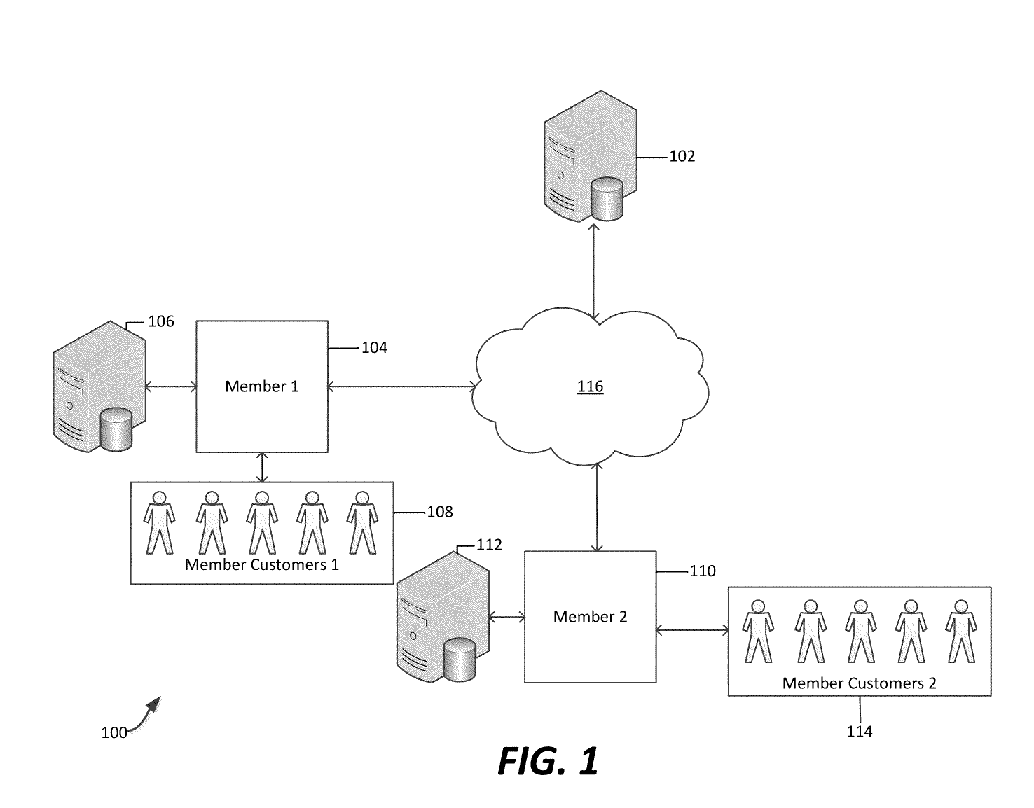

FIG. 1 illustrates an exemplary embodiment of a benefits tracking and allocation system 100. The system 100 includes a benefits tracking and allocation server(s) 102, a first member 104, a first member server 106, first member customers 108, a second member 110, a second member server 112, second member customers 114, and a network 116. It is understood that alternate embodiments of the system 100 may include further members, member servers, member customers, and networks, as is suitable for the purposes of the particular system.

The system 100 includes the benefits tracking and allocation server(s) 102 which collects and organizes information, allocates benefits, and presents information. It is understood that the benefits tracking and allocation server 102 may include one or more servers, depending on the needs of the system, the amount of information stored therein, and other like factors. The server 102 has a database including members (e.g., first and second members 104, 110, and particular customers associated with each member). The benefits tracking and allocation server 102 communicates across the network 116 to the first member server 106 and the second member server 112.

The network 116 communicates digital data between one or more computing devices, such as between the servers 102, 106, and 112. Examples of the network 116 include a local area network and a wide area network, such as the Internet. In some embodiments, the network 116 includes a wireless communication system, a wired communication system, or a combination of wireless and wired communication systems. A wired communication system can transmit data using electrical or optical signals in various possible embodiments. Wireless communication systems typically transmit signals via electromagnetic waves, such as in the form of radio frequency (RF) signals. A wireless communication system typically includes a RF transmitter for transmitting radio frequency signals, and an RF receiver for receiving radio frequency signals. Examples of wireless communication systems include Wi-Fi communication devices (such as utilizing wireless routers or wireless access points), cellular communication devices (such as utilizing one or more cellular base stations), and other wireless communication devices.

The first and second members 104, 110 may be any business or system having customers. In particular, the system 100 is particularly suited for members having repeat customers. For example, in some embodiments, the first and second member 104, 110 may be repair shops, dealerships (e.g., automobile or recreational vehicle dealerships), retail stores, grocery stores, or the like. In particular embodiments, the first and second member 104, 110 are automobile or recreational vehicle dealers or service shops. For purposes of this disclosure, the first and second members 104, 110 will be referred to as vehicle dealers; however, it is understood that the first and second members 104, 110 may include a broader scope, as discussed above.

In the present example, the first and second members 104, 110 are independent of each other. However, in other embodiments, the first and second members 104, 110 may be related (e.g., part of a common dealership group or otherwise interrelated). The first member customers 108 are customers of the first member 104 and second member customers 114 are customers of the second member 110.

Upon interacting with a customer, the first and second members 104, 110 record the interactions in the servers 106, 112, respectively. The servers 106, 112 may be record-keeping systems designed for this purpose, but could also be everyday computers utilized by the first and second members 104, 110 to record day-to-day occurrences and transactions of the first and second members 104, 110. For example, the first and second member servers 106, 112 may store transactional information (e.g., service records) regarding a number of either existing or future services performed by the members 104, 110 on behalf of member customers 108, 114. The transactional information can relate to, for example, product orders, repair orders, and/or other customer transactions. In particular, the transactional information can relate to either a repair or service provided (e.g., representing a past service), or one or more services contracted-for (e.g., representing a future, pre-paid service). A repair order, for example, may describe a particular service rendered by a member (e.g., first or second members 104, 110) for a customer and may include a cost of the service. Services contracted-for can include, for example, pre-paid maintenance services, such as services that are purchased in a group for use periodically by a member customer.

At predetermined intervals (e.g., daily, weekly, bi-weekly), the server 102 connects to the first and second member servers 106, 112 to retrieve all new customer transactions. These transactions can be received in the form of a text file, an XML file, or some other aggregation of transaction records. The server 102 then processes and organizes the customer transactions. For example, the server 102 may identify a member name and customer name associated with the customer transaction. Thereafter, the server 102 may access a stored list of customers associated with a member and determine whether a particular customer transaction involves a customer on the stored list. If so, the server 102, may access predefined algorithms associated with the member including rules defining benefit allocation and/or redemption. Based on the rules, the server 102 may allocate or redeem a certain amount of benefits to the customer, for example based on an update to a customer record triggered by a new service record or other customer transaction at a member. In some embodiments, as will be described below in greater detail, the server 102 may create a customer account for a customer that is not on the stored list of customers.

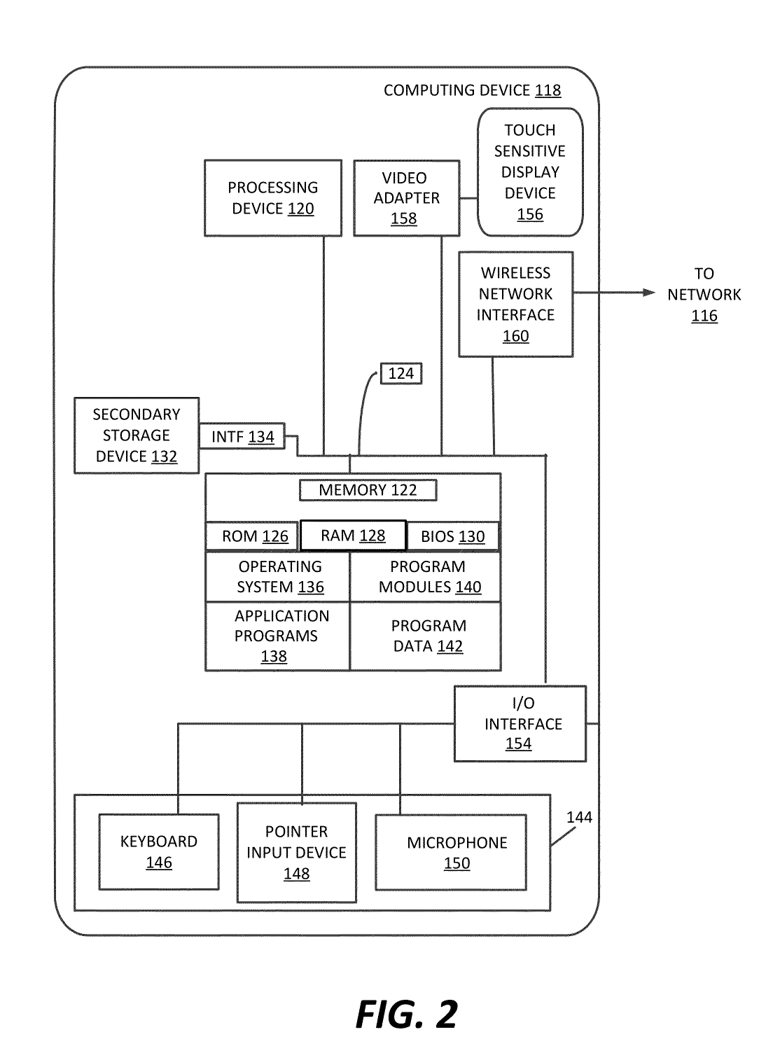

FIG. 2 illustrates an exemplary architecture of a computing device that can be used to implement aspects of the present disclosure, including the servers 102, 106, 112 and will be referred to herein as the computing device 118. The computing device 118 is used to execute the operating system, application programs, and software modules, described herein.

The computing device 118 includes, in some embodiments, at least one processing device 120, such as a central processing unit (CPU). A variety of processing devices are available from a variety of manufacturers, for example, Intel or Advanced Micro Devices. In this example, the computing device 118 also includes a system memory 122, and a system bus 124 that couples various system components including the system memory 122 to the processing device 120. The system bus 124 is one of any number of types of bus structures including a memory bus, or memory controller; a peripheral bus; and a local bus using any of a variety of bus architectures.

Examples of computing devices suitable for the computing device 118 include a desktop computer, a laptop computer, a tablet computer, a mobile phone device such as a smart phone, or other devices configured to process digital instructions.

The system memory 122 includes read only memory 126 and random access memory 128. A basic input/output system 130 containing the basic routines that act to transfer information within computing device 118, such as during start up, is typically stored in the read only memory 126.

The computing device 118 also includes a secondary storage device 132 in some embodiments, such as a hard disk drive, including magnetic and solid state drives, for storing digital data. The secondary storage device 132 is connected to the system bus 124 by a secondary storage interface 134. The secondary storage devices and their associated computer readable media provide nonvolatile storage of computer readable instructions (including application programs and program modules), data structures, and other data for the computing device 118.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Such embodiments include non-transitory media.

A number of program modules can be stored in secondary storage device 132 or memory 122, including an operating system 136, one or more application programs 138, other program modules 140, and program data 142.

In an exemplary embodiment, the data stored in program data 142 can be represented in one or more files having any format usable by a computer. Examples include text files formatted according to a markup language and having data items and tags to instruct computer programs and processes how to use and present the data item. Examples of such formats include html, xml, and xhtml, although other formats for text files can be used. Additionally, the data can be represented using formats other than those conforming to a markup language.

In some embodiments disclosed herein, findings are stored as data items in one or more data records. In some embodiments, data records are a set of one or more data items, such as in a format that can be read by a computing device. An example embodiment is a database record. Other examples of data records include tables, text files, computer executable files, data structures, or other structures for associating data items.

In some embodiments, computing device 118 includes input devices to enable inputs to the computing device 118. Examples of input devices 144 include a keyboard 146, pointer input device 148, microphone 150, and touch sensitive display 156. Other embodiments include other input devices 144. The input devices are often connected to the processing device 120 through an input/output interface 154 that is coupled to the system bus 124. These input devices 144 can be connected by any number of input/output interfaces, such as a parallel port, serial port, game port, or a universal serial bus. Wireless communication between input devices and interface 154 is possible as well, and includes infrared, BLUETOOTH® wireless technology, 802.11a/b/g/n, cellular, or other radio frequency communication systems in some possible embodiments.

In some embodiments, a touch sensitive display device 156 is also connected to the system bus 124 via an interface, such as a video adapter 158. The touch sensitive display device 156 includes touch sensors for receiving input from a user when the user touches the display. Such sensors can be capacitive sensors, pressure sensors, or other touch sensors. The sensors not only detect contact with the display, but also the location of the contact and movement of the contact over time. For example, a user can move a finger or stylus across the screen to provide written inputs. The written inputs are evaluated and, in some embodiments, converted into text inputs. It is understood that all user selections described herein may be conducted by utilizing a finger to select or move an item on the touch sensitive display device 156. The touch sensitive display can use various different technologies such as resistive, surface acoustic wave, capacitive, infrared grids, projected optical imaging, dispersive signaling, and any other suitable touch technology. User interfaces displayed on the touch sensitive display device 156 can be operated with other types of input devices such as a mouse, touchpad, or keyboard. Other embodiments can use a non-touch display that is operated with an input device such as a mouse, touchpad, keyboard, or other type of input device.

In addition to the display device 156, the computing device 118 can include various other peripheral devices (not shown), such as speakers or a printer.

When used in a local area networking environment or a wide area networking environment (such as the Internet), the computing device 118 is typically connected to the network through a network interface, such as a wireless network interface 160. Other possible embodiments use other communication devices. For example, some embodiments of the computing device 118 include an Ethernet network interface, or a modem for communicating across the network.

The computing device 118 typically includes at least some form of computer-readable media. Computer readable media includes any available media that can be accessed by the computing device 118. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 118. Computer readable storage media generally includes a tangible storage media or device, rather than including solely transitory signals.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

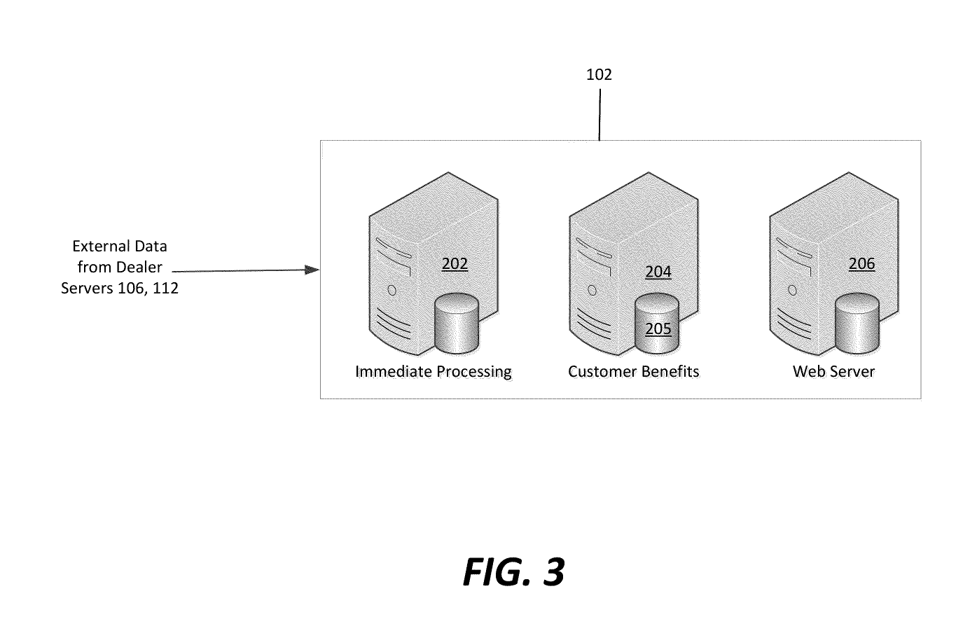

FIG. 3 illustrates an exemplary architecture of the benefits tracking and allocation server 102. In the example, the server 102 includes a processing server 202, a customer benefits server 204, and a web server 206. The servers 202, 204, and 206 work in conjunction to complete the tasks of the server 102. It is understood that though the server 102 is illustrated as including multiple internal servers, in other embodiments, the server 102 is configured to accomplish all of the tasks of the servers 202, 204, and 206.

The processing server 202 is configured to periodically extract customer data from external dealers (e.g., member servers 106, 112). In some embodiments, the processing server 202 connects directly to the member servers 106, 112 via the network 116. However, in alternate embodiments, the processing server 202 may connect to an intermediate server (not shown) which collects data periodically from the member servers 106, 112 and stores the collected data for later retrieval by the processing server 202. In both embodiments, the processing server 202 may be programmable to retrieve data (either from the member servers or from an intermediate server) within a predefined amount of time, for example, hourly, daily, bi-weekly, weekly, or the like. In other embodiments, the processing server 202 may receive a communication from one or more member servers or an intermediate server indicating that new data exists for processing. Thereafter, the processing server 202 may retrieve the data regardless of whether a predefined amount of time has elapsed.

In some embodiments, the processing server 202 is configured to filter the incoming data. For example, the processing server 202 analyzes the incoming data and identifies all customer transactions. That is, the processing server 202 selects product orders, repair orders, service receipts, and any other receipts or data relating to customer transactions, and removes these items for further processing. This data is then transmitted to or from the processing server 202 to the customer benefits server 204.

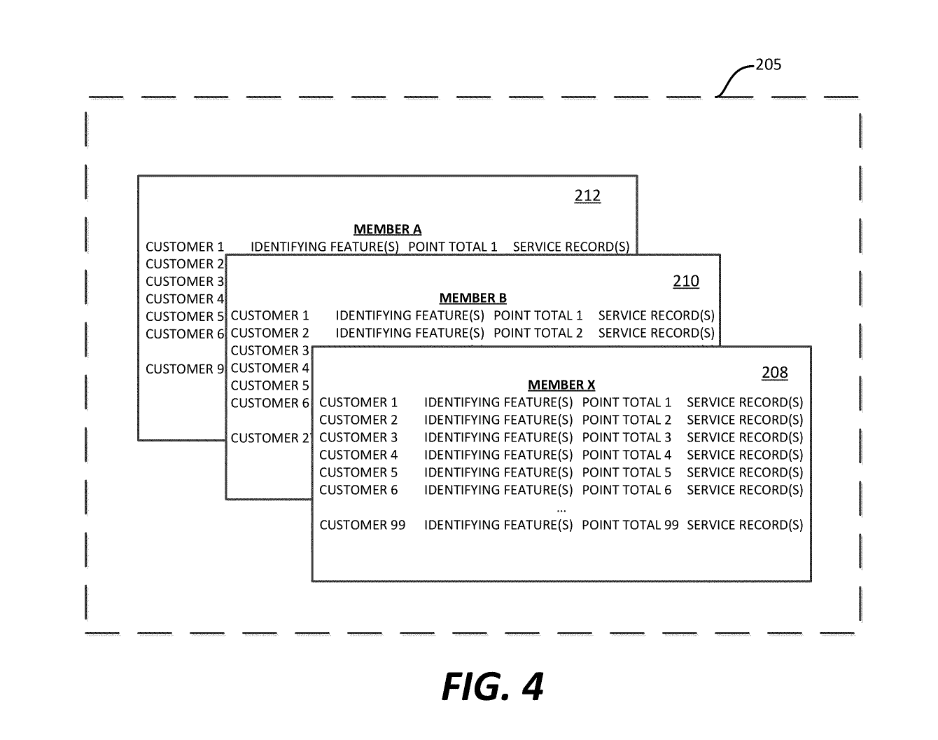

The customer benefits server 204 is configured to manage, allocate, and redeem benefits to customers based on the received data. In some embodiments, the customer benefits server 204 includes a database 205 having members and associated customer accounts (See FIG. 4). Each list may include customers associated with the member, and identifying features of each customer, including, for example, a name, address, vehicle identification number (“VIN”), unique customer code, date of birth, phone number, and/or any other identifying information. The list may also include a counter of benefits for each customer, including, among other benefits, a loyalty rewards level assigned to the member customer or a number of loyalty credits awarded to the member customer, or one or more pre-paid services (including the service purchased as pre-paid, amount paid, and number of services available and/or redeemed). In still further examples, the list, and each record therein, can include information gathered as part of a service record (also known, in some cases, as a repair record), including services performed, services offered, a state of a vehicle that was the subject of the service, including any advised service to be performed and an indication of whether a member customer agreed with or declined such recommendations, and any additional upsell goods/services included in the service. The information associated with each member customer can extend to general transactions with the member as well, such as offers for other goods or services that may not be part of a service record, but rather relate to past or future purchases of goods/services (e.g., purchases of pre-paid goods/services).

In some embodiments, the customer benefits server 204 also stores, in database 205, information regarding the customer that is not associated with benefits. For example, additional information can be stored relating to accounting information for each member. In such embodiments, the customer benefits server 204 manages account balances for each member based on the information received from each member, for determination of not only benefits, but account balances, prices of goods/services charged by the member, profitability levels, and other information. Such a system may act, in instances where it is used in parallel with a member's accounting system (e.g., a dealer management system typically operated by a vehicle dealer or service shop), as an integrated system for managing accounting aspects of a particular member in a way that accounts for benefit programs that are implemented by that member.

As further discussed below, the customer benefits server 204 can, in such embodiments, manage an escrow account for purchased benefits (e.g., pre-paid services) and can track redemption of such benefits and associated price of the goods/services provided by way of those benefits (including changes in price over time), thereby providing integrated marketing and accounting functions for such members. This allows members utilizing the benefits tracking and allocation server 102 to determine how best to market and allocate benefits, and determine the effectiveness of such benefits. In some embodiments, the customer benefits server 204 maintains the customer accounts, and the entity managing customer benefits server 204 manages the funds associated with those customer accounts. However, in some embodiments, although the customer benefits server 204 maintains escrow account balances, those escrow accounts can be held by the member, rather than a third party managing the customer benefits server 204 or some other third party. In such cases, the member receives access to funds provided by the customer associated with that member and which were used for prepayment of goods and/or services. Those funds can be routed, for example, to an account at a financial institution (not shown) which is owned or controlled by the member, and which can be accessed by the member.

Upon receiving data from the processing server 202, the customer benefits server 204 identifies the member and the customer (or identifying features of the customer) associated with the data. Thereafter, the customer benefits server 204 accesses and searches for a stored list of customers associated with the identified member. After accessing the list, the customer benefits server 204 next searches the list with the identified customer or extracted known features of the customer. If there is a match and the identified customer is found on the list, the customer benefits server 204 next allocates (or subtracts) benefits to the customer's account based on the data (i.e., whether loyalty points are to be rewarded, or whether a prepaid service has been redeemed).

In some embodiments, the identified customer retrieved from the data does not exist on the list of customers stored in the customer benefits server 204. In such examples, the customer benefits server 204 may either discard the data or create a customer account with the identified customer and the identified member. Thereafter, the customer benefits server 204 allocates benefits to the newly created customer account based on the data.

To allocate or redeem benefits associated with a customer account, the customer benefits server 204 accesses individualized rules for each member defining benefit allocation. These rules may also be stored in the database 205. In particular, the rules may define how many points, for example, to award a customer based on the type of service or product bought or the amount of money spent at the member's dealership. The rules may also define, for example a type or limitation on types of services or goods that can be redeemed when purchased on a pre-paid basis. Rules may differ for each member in the system 100, and thus, the customer benefits server 204 must access the unique rules associated with the identified member prior to allocating or redeeming any benefits to the customer account. After the rules are accessed, the customer benefits server 204 utilizes the stored algorithms to calculate a point score or other type of account credit, which is then added to or subtracted from the customer's account.

To subtract benefits from the customer account, the customer benefits server 204 is accessed based on rules, which can be stored in database 205. The benefits subtracted will generally be, in the context of pre-paid goods/services, for a specific good or service. A member can access the web server 206 to verify that a member customer has pre-paid for a particular good or service, and can therefore enter a transaction for that good or service once verified. The good or service selected can then be entered as a further transaction which will update at the customer benefits server 204 similarly to allocation of benefits, thereby causing subtraction of the good or service from the customer account.

Though benefits are discussed herein as points, credit, or specific prepaid services which may be redeemed by the customer with the member, it is understood that any number of reward systems may be utilized, such as gifts, rewards, prizes, coupons, discounts, money, or the like may be utilized by the system 100 based on the agreement between the members and the host of the benefits tracking and allocation server 102.

After updating customer benefits, the changes are transmitted to the web server 206. The web server 206 is configured to create and update web pages based on the customer accounts stored in the database 205. The web server 206 updates web content with the newly added or removed benefits, customer accounts, and the like. The web content may be viewed by a customer who is interested in viewing his/her benefits, account history, account details, identifying information, and the like.

The web server 206 also presents user interfaces viewable by members, for example allowing each member to view individual records or reports regarding customer activity, such as repeat customer rates, pre-paid account balances, available money capable of being realized from the pre-paid account balances, and other reports indicating the types of goods or service provided by that member, the types of good/service that is purchased on a pre-paid basis, a rate at which additional goods/services are provided in connection with the pre-paid good/service (e.g., upsell occurrences), or other metrics useable to track the value of the pre-paid good/service. Similarly, the user interfaces viewable by members allow the members to view rates at which loyalty credits are redeemed for discounted goods/services.

In some embodiments, the web server 206 also presents a user interface to a member customer, for example allowing that member customer to view his/her contact information and affiliation with a particular member, as well as to view historical services or goods purchased from that member, or the existence of either loyalty credits or pre-paid credits managed by the benefits tracking and allocation server 102 generally.

In some embodiments, the web server 206 is also configured to send email notifications to customers upon updating customer accounts or creating new accounts. If the database 205 includes customer email addresses for the updated accounts, these email addresses are either sent to the web server 206 by the customer benefits server 204 or alternatively accessed by the web server 206. A standardized email including an explanation of updates may be sent to the customer. In the case of a new account, an email may be sent to the customer including a notification of enrollment and/or instructions on how to set up and access a web page including customer account details. The web server 206 can also be configured to send email offers or reminders to customers, for example reminding the customer of the existence of a pre-paid good/service that the customer previously purchased, or providing an offer of some additional, discounted good/service in association with such a reminder. Additionally, such communications can include information regarding loyalty credit balances, or other details regarding accrued benefits.

Referring to FIG. 3 generally, it is noted that use of the server 102 allows for regular, periodic aggregation of records for each member, ensuring that a complete record of transactions performed by that member is maintained. Accordingly, in cases where a member's own transaction logs are badly maintained or otherwise not integrated with marketing or benefits tracking systems, the server 102 and associated functionality discussed herein allows for a more complete set of records relating to financial transactions, as well as integration of such record with benefit programs. This is particularly useful in the context of automobile and recreational vehicle dealers and service stations, where transactional data is at best maintained in a dealer management system that generally lacks integration with benefit systems, and which can lack inclusive data. By capturing such information at server 102, a duplicate of the dealer management system data can be automatically maintained for purposes of auditing, as well as for administering benefit programs such as loyalty and pre-paid good/service programs by such dealers.

In addition, it is noted that servers 202, 204, 206 are utilized for purpose of illustration, showing one possible arrangement by which server functionality can be dispersed across computing systems where two or more virtual or physical systems are used to represent server 102. However, it is recognized that alternative arrangements in which different numbers of servers, or different assignment of tasks among servers, may be used.

FIG. 4 illustrates an exemplary architecture of the database 205, shown in FIG. 3. The database 205 includes a first customer account list 208, a second customer account list 210, and a third customer account list 212. Though three customer account lists are shown in the present example, it is understood that more or less lists may be utilized for the same or similar purposes. Further, it is understood that though the database 205 is shown to include lists, any similar data structure for storage may be utilized, for example, a matrix, a table, a spreadsheet, or the like, and/or any combination thereof.

As stated above, upon receiving customer transaction information, such as, for example, a vehicle repair order, the customer benefits server 204 identifies a member associated with the vehicle repair order. Next, the customer benefits server 204 accesses the database 205 and retrieves a list of customers associated with the identified member. For example, if the vehicle repair order identifies “Member X”, the customer benefits server 204 retrieves the first customer account list 208. Then, the customer benefits server 204 extracts the customer information on the vehicle repair order and determines whether a customer account associated with “Member X” on the first customer account list 208 matches the customer information on the vehicle repair order. Customer information may include, for example, identifying features of each customer, such as, a name, address, vehicle identification number (“VIN”), unique customer code, date of birth, phone number, and/or any other identifying information. If there is a match, the customer benefits server 204 next allocates or redeems benefits associated with the customer's account based on the vehicle repair order and the predefined algorithms associated with “Member X”, based either on a current purchase (rewarding loyalty points) or a prior purchase (redeeming prepaid goods/services). Though data structures illustrating unique predefined algorithms for each member as not shown in the FIG. 4, it is understood that alternate embodiments of the database 205 include this information.

If there is no match between the customer information extracted from the vehicle repair order and the first customer account list 208, the customer benefits server 204 may create a new customer account on the first customer account list 208. Next, the customer benefits server 204 allocates benefits (in this case, loyalty benefits) to the new customer account based on the vehicle repair order and the predefined algorithms associated with “Member X.” In alternate embodiments, if there is no match, the vehicle repair order is discarded and no further action is taken by the customer benefits server 204.

In the case of a pre-paid good or service, the customer information can be used to compare to customer information at the customer benefits server 204, for example to update that customer's account with the associated member, thereby updating a number of prepaid goods/services that have been redeemed. It is noted that, if there is no match between customer information extracted from a vehicle repair order and a customer account list 208, it is likely not the subject of a previously purchased pre-paid program (unless identifying information associated with the customer was otherwise erroneous). In this case, the repair order may be determined to be, for example, associated with a new pre-paid group of goods and/or services, or a trigger to initiate an automatic registration by a user for pre-paid goods and/or services.

In connection with the present disclosure, it is recognized that the customer account lists 208-212 can include a variety of other information beyond the customer identifying information and benefit points. In particular, in some embodiments, substantially all of the information collected by a member can be stored in association with each customer account in a customer account list, with each customer account corresponding to a particular record in database 205. This can include, for example, a complete record of goods or services purchased by a customer, as well as amount paid for such goods/services (shown generically as “Service Record(s)”). It can also include details regarding a customer visit to a member (e.g., an automobile or recreational vehicle dealer or repair shop), such as other products or services offered but declined. Such details can include maintenance services deferred by the customer, which are tracked for purposes of reminding that customer of the services during a subsequent visit or in a subsequent communication. Over a timeframe in which the customers visit the member, those customers can aggregate service records from one or more visits by the customer.

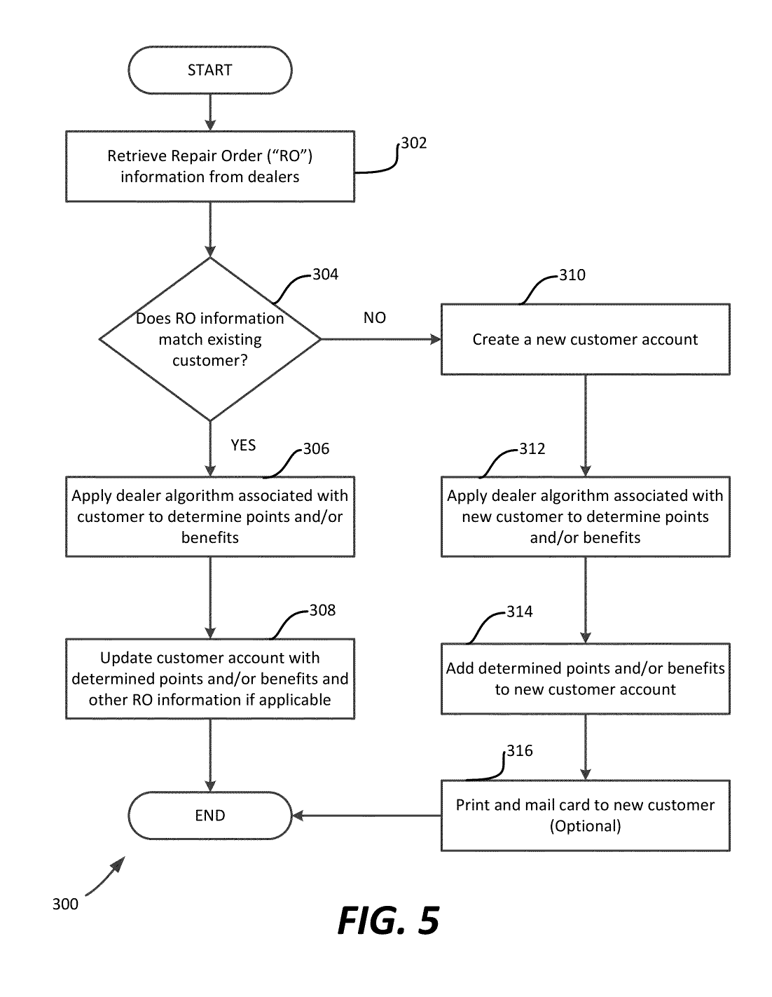

FIG. 5 is a flow chart illustrating a method 300 for tracking and allocating benefits. In general, the method 300 is an example method performed by the benefits tracking and allocating server 102. Operations of the method 300 may be implemented by the components and structure described above with reference to FIGS. 1-4.

The method 300 begins at operation 302 where the customer transactions, such as repair orders are retrieved from members, such as the dealers. In some embodiments, the server 202 is configured to periodically extract customer data from external dealers (e.g., member servers 106, 112) or from an intermediate server, as discussed above. The processing server 202 may be programmable to retrieve data (either from the member servers or from an intermediate server) within a predefined amount of time, for example, hourly, daily, bi-weekly, weekly, monthly, or the like. Alternatively, the processing server 202 may receive a communication from one or more member servers or an intermediate server indicating that new data exists for processing, prompting the server 202 to retrieve the data.

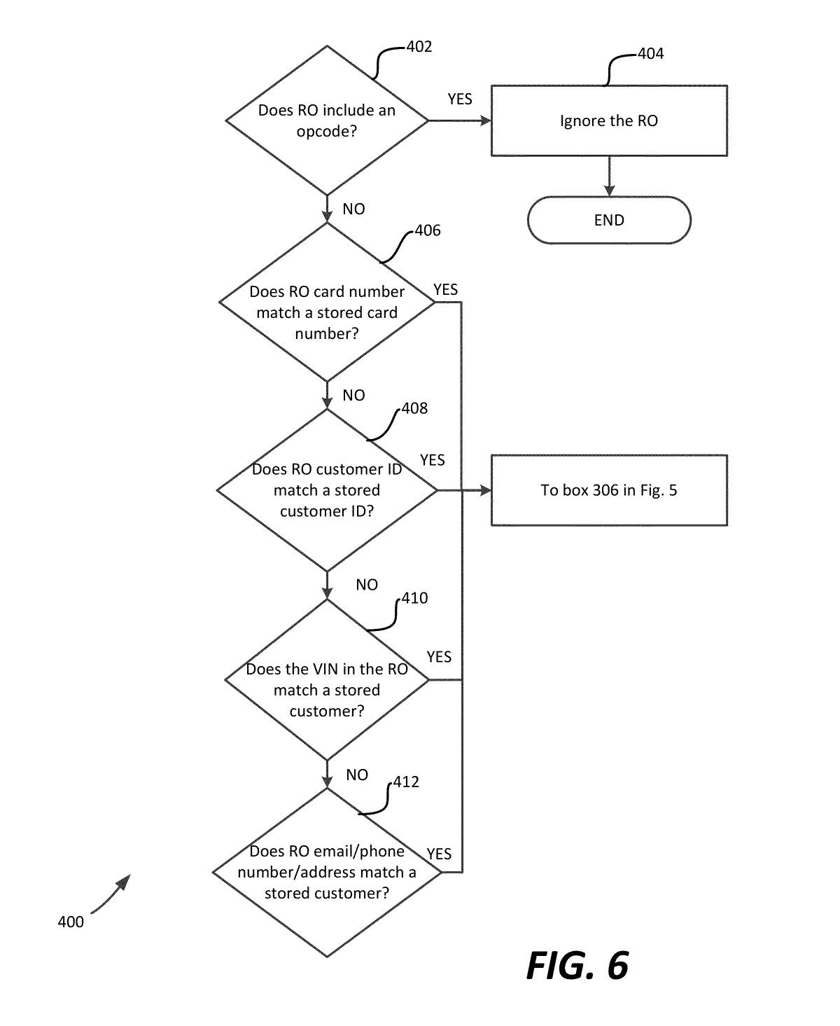

The method 300 proceeds next to operation 304 where the server 102 determines whether customer and member information on the repair order matches preexisting customer accounts in the system. As discussed above, the system may utilize a database that stores customer and member information. In some embodiments, this database is searched with the customer and member information on the repair order. More information about this operation is discussed below with reference to FIG. 6.

If there is a match between the customer information on the repair order and a pre-stored customer account, the method 300 proceeds to operation 306. At operation 306, a unique dealer algorithm is applied to determine the amount and type of benefits (or pre-paid credits) that should be added to or subtracted from the customer account. For example, in some cases, the quantity of benefits (e.g., loyalty points) can be based on the amount of money spent at the dealer, the type of service bought, the amount of benefits redeemed at the dealer, or the like. Dealers can specify these rules prior to system operation, and in some examples, these rules are stored in the server 102. In alternate embodiments, a dealer may not specify rules, and instead, a default generic rule set may be utilized. In the case of pre-paid goods/services, the match between customer information and the pre-stored customer account is required, since a customer account would be required to store credits associated with the customer. In such circumstances, operation 306 corresponds to validation that the account associated with the customer exists (i.e., the correct customer is referred to by the repair order) and that the good or service provided by the dealer corresponds to that which was pre-purchased.

Next, the method 300 proceeds to operation 308 where the calculated benefits total are added to or subtracted from the customer account. This new value is stored in the server 102. In addition, the server 102 may also store the prior benefits value (so that a historical view can be presented to the customer), a copy of the repair order, or the like. Further, the server 102 may also update the customer account with any additional information that is found on the repair order, but is not stored in the customer account, such as, for example, a vehicle identification number, or any other customer identifying features.

If there is not a match between the customer information on the repair order and a pre-stored customer account, the method 300 may proceed to operation 310 where a new customer account is created (e.g., in the case of newly purchased services or formation of a new pre-paid account). To create an account, the system 100 may simply store customer information, associated member information, and repair order information, for example. Next, the method 300 proceeds to operations 312 and 314 which are similar to the operations 306 and 308 discussed above.

Finally, the method 300 proceeds to operation 316 where a new account is associated with a customer, and a new card is optionally provided to the new customer. Delivery of a new card to a customer can take numerous forms. In some embodiments, the card may be held at a member location (e.g., a dealer), and handed to the customer at the time of the particular transaction that is performed (e.g., the sale of a good or service, or of prepaid goods/services). In alternative embodiments, the new card can be printed and mailed to the new customer. Other card delivery systems could be utilized as well. In some embodiments, all updates to the server, such as those in operations 308 and 314 are added to a webpage which can be accessed over the network 116 by the dealers and/or customers. Further, notification emails may also be sent to the dealers and/or customers indicating an update to the customer accounts, and no card may be needed at all. In such cases, the new account is generated and associated with a customer and the customer is so notified.

It is noted that, in various embodiments, the creation of a new account, as well as the other aspects of FIG. 5 discussed above, can optionally be performed either automatically (e.g., in case a card need not be issued), or could include some manual operations performed by a member. In the at least partially manual process, an employee of the member may issue the customer a card, which can be used by the customer to redeem pre-paid services, store benefit information, or otherwise access a benefit or other customer account.

FIG. 6 is a flow chart illustrating a method 400 for tracking and allocating benefits. In general, the method 400 is an example series of operations included in the operation 304, discussed in the method 300. Operations of the method 400 may be implemented by the components and structure described above with reference to FIGS. 1-4.

The method 400 begins at operation 402 where the server 102 searches the repair order to determine whether there is a match between the customer information on the repair order and the customer account. In some embodiments, a dealer may, however, request that no benefits be added to a customer account based on a transaction. In these situations, a dealer may include a code on the repair order (e.g., a predetermined operation code, or “op code”) indicating this preference. In some embodiments, the server 102 first searches the repair order for the particular operation code. If the “ignore” record operation code is found, the method 400 proceeds to operation 404, and the repair order is ignored and no further actions are taken.

If an operation code is not found, the method 400 proceeds to operation 406 where customer information is extracted from the repair order and compared to a stored list of customer's associated with the member. For example, in the operation 406, the server 102 determines whether a membership number found on the repair order matches a membership number in the list of customers. If a membership number is found, the system proceeds to operation 306, as discussed in FIG. 5.

Likewise, if a membership number is not found, the system proceeds to operations 408, 410, and 412 in turn. For example, the system will next determine whether a unique customer identification number present on the repair order matches a customer account in the server. If not, the system will next determine whether a VIN on the repair order matches a customer account in the server. Finally, if the system is unsuccessful in finding a match, the system will next determine whether other personal customer information, such as, for example, an email address, physical address, or phone number found on the repair order matches a stored customer account. If any of this information is found in the database, the system proceeds to operation 306, as discussed in FIG. 5.

Although not shown in the present example, in some embodiments, a combination of identifying customer features is required for a successful match with the database. For example, in some examples, a VIN alone will not suffice. Instead, a customer name, physical address, and/or email address must also match the database to proceed to operation 306. The system is programmable to include a combination of any of the searches discussed in the example method, and other searches not specifically discussed herein.

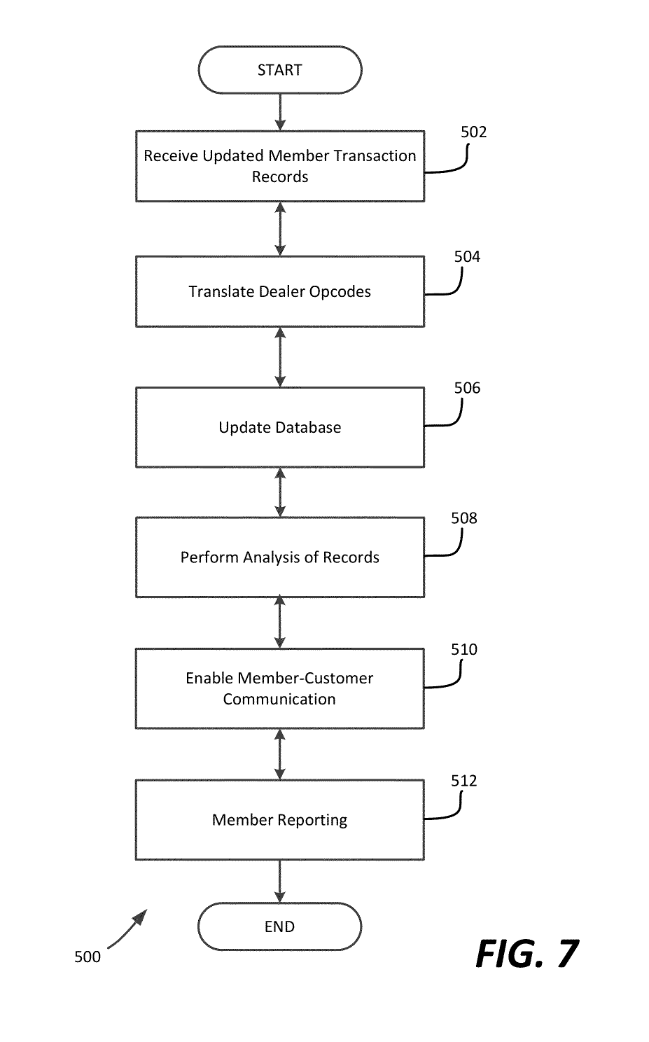

Referring now to FIG. 7, a general flowchart of a method 500 for tracking benefits, including both loyalty and pre-paid system benefits, are shown, according to an example embodiment. The method 500 provides for integrated tracking of sales, costs, and associated marketing and benefit administration for members, such as automobile or recreational vehicle sales and service entities, and involves use of the processes discussed above in connection with FIGS. 5-6 for administration of such programs, while providing an overall process flow for operation of a benefits tracking and allocation system, such as benefits tracking and allocation system 100 of FIG. 1.

In the embodiment shown, the method 500 begins at operation 502, at which updated member transaction records are received. The member transaction records can be received on a weekly, daily, or hourly basis, and are retrieved in the format of the dealer, i.e., with proprietary operation codes (op codes) configured by a particular member, and associated descriptions of good and/or services associated with those operation codes. At operation 504, the received records are processed for storage in a database, such as database 205. This can include, for example, translating the received operation codes into one or more universal operation codes associated with a particular good or service provided, and converting member transaction records for storage in the database 205 at operation 506. This conversion can include, for example, reformulating data or extracting relevant information for storage in the database 205.

It is noted that, in some embodiments, operation 506 can include adding particular operation codes, or translating proprietary operation codes that are affiliated with particular actions taken by a member other than for a particular good or service. For example, in some embodiments, operation codes can be used to track services that are declined by a member customer, or whether a marketing campaign has been offered to or presented to a customer having a particular type of service. These operation codes could be translated as noted above, or could be added by the server 102, for example based on management of such marketing or service offerings at the server 102.

In some embodiments, in particular those in which database 205 is accessible via a web interface on server 102, operation 506 can also include direct access and updating of profiles and accounts of members and member customers. Such updated profiles can include an indication of a change in price for a good or service, a note that a particular service has been previously declined (and a number of times a particular services has been declined), a change in contact information of a member customer, or other information associated with the member customer.

With updated records, any of a number of operations can be performed. For example, at operation 508, records of database 205 are analyzed to determine one or more trends associated with each member. This can include, for example, determinations of the effectiveness of either a loyalty-based program or a pre-paid goods/services program. With respect to a loyalty-based program, such analysis can include, for example, a determination of a rate of repeat visits (and frequency) to a particular member by a member customer, overall money spent (both overall and on a per-visit basis), and other individual metrics. For determinations of the effectiveness, or administration, of a pre-paid good/service arrangement, analysis of various service record data and/or other transactions could be performed.

In some embodiments, operation 508 includes determining one or more actions to take with respect to a particular member customer. This can include, for example, generating a suggestion for review and adoption by a member to contact one or more customers with a particular offer or type of pre-paid good/service, for example due to its popularity, its typical success in association with one or more upsell efforts, or other types of analysis.

In one example embodiment, operation 508 analyzes records associated with a particular customer to determine that the customer has previously opted to not purchase one or more types of goods or services in an expected timeframe. This may include, for example, an oil change or fluid replacement within a particular timeframe. It may also or alternatively include a determination that a customer has declined services that were recommended during a visit to the member, and that the customer may wish to have such services performed in the future. Such declined services records can, in some embodiments, also be assigned operation codes that correspond to particular declined services.

At operation 510, member-customer communication can be established, for example based on the analysis performed at operation 508. This communication can be, for example, a reminder of the existence of any remaining pre-paid goods/services that the customer has previously purchased, an offer for additional discounts on services purchased when associated with a particular pre-paid good/service, a reminder to perform previously-declined services, or other types of communications that are likely of interest to the customer and which would be readily incorporated into either loyalty or pre-paid benefit program administration.

At operation 512, one or more reports can be generated for a member. The reports can be, for example, used in connection with a dealer management system or other accounting system. Such reports can include information relating to goods/services sold by the member, including trends, upsell success rates, typical declined services, or other types of metrics. In addition, in the case of use in an automobile or recreational vehicle dealer or repair shop, duplication of a dealer management system allows for management of financial reporting as well via the server 102. In an example application of such reporting, one or more reports generated during operation 512 can integrate accounting and benefit programs; for a pre-paid system, such reports may be used to determine times at which pre-paid services were purchased, and an amount of time before such purchases have expired, thereby allowing the member to realize as profit the un-redeemed goods/services purchased.

In connection with the method 500 of FIG. 7, it is noted that one or more operations 502-512 can be performed in a variety of orders, and as such represent various modules executable on a server, such as server 102. Accordingly, such operations can be performed, for example using a web interface, at a member location, to access information about that member or member customers, and to administer such benefit programs.

Referring to FIGS. 1-7 generally, it is noted that the integration of accounting systems of a member with a benefits tracking and allocation server 102 can provide numerous advantages to a member. For example, members are able to quickly track escrow account balances associated with prepaid goods/services, and are quickly able to realize profit based on unclaimed prepaid goods/services based on such integration, as well as automatically adjust profit margins on prepaid goods/services based on the cost of such goods/services at the time each prepaid good or service is redeemed by a customer. Furthermore, since the benefits tracking and allocation server 102 automates management of benefits, it allows members to easily track large numbers of member customers, either at a particular location, across a collection of affiliated locations (which may correspond to one or more members), and across a wide variety of goods and services. For example in the context of an automobile dealership, benefit programs may be provided by a particular car manufacturer; in such cases, benefits may only be readily available for goods or services associated with a particular brand of automobiles. By way of contrast, the present application allows for benefits to be assigned on a member by member (e.g., dealer-by-dealer) basis, thereby allowing each member to specifically define different types and/or levels of benefits for each good or service provided by that member, irrespective of the identity or brand of the good or service.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternative embodiments having fewer than or more than all of the features herein described are possible.

While various embodiments have been described for purposes of this disclosure, various changes and modifications may be made which are well within the scope of the present disclosure. Numerous other changes may be made which will readily suggest themselves to those skilled in the art and which are encompassed in the spirit of the disclosure and as defined in the appended claims.

1. A system comprising:
a benefits server comprising a database including stored customer accounts associated with at least one member having at least one member server, the benefits server configured to:
communicate with the at least one member server via a network;
retrieve customer transaction data from the at least one member server, the customer transaction data indicative of interactions between the at least one member and customers of the at least one member;
extract customer information from the customer transaction data;
search the database for the customer transaction data; and
when the customer information is found in the database, update a customer account in the database with the customer transaction.

2. The system of claim 1, wherein the benefits server is configured to, as part of the update of the customer account, update benefits information associated with the customer, the benefits information including at least one of loyalty credit or pre-payment.

3. The system of claim 1, wherein the benefit server is further configured to retrieve customer transaction data from the at least one member server daily.

4. The system of claim 1, further comprising a plurality of members including the at least one member.

5. The system of claim 4, further comprising at least one member server associated with the at least one member.

6. The system of claim 1, wherein the benefit server comprises:
a processing server configured to receive the customer transaction data and extract usable data;
a customer benefits server configured to receive the usable data from the processing server and update the stored customer accounts based on the usable data; and
a web server configured to receive information indicative of updates made to the stored customer accounts and update webpages based on the information.

7. The system of claim 1, wherein the benefit server is further configured to send an e-mail to a customer associated with the customer account that was updated, the e-mail including a notification of the update.

8. The system of claim 1, wherein the benefit server is further configured to create a new customer account when the customer information is not found in the database.

9. The system of claim 1, wherein the customer transaction data is at least one automotive repair order.

10. The system of claim 1, wherein the at least one member is an automotive dealership.

11. The system of claim 10, wherein the at least one member comprises a plurality of members including a plurality of automotive dealerships.

12. The system of claim 1, wherein the benefits server is further configured to update a web page to reflect the update to the customer account, the web page accessible to customers of the at least one member.

13. A method comprising:
retrieving a repair order from a first member at a benefits server;
identifying customer information and member information associated with the repair order;
determining whether the customer information matches a stored customer account;
when there is a match, applying a stored algorithm associated with the first member to determine a calculated benefits value; and
adjusting a stored benefits value in the stored customer account based on the calculated benefits value.

14. The method of claim 11, further comprising:
when there is not a match, creating a new customer account associated with the repair order and a customer associated with the repair order.

15. The method of claim 11, further comprising:
when there is not a match, creating a new customer account;
applying a stored algorithm associated with the first member to determine a benefits value;
adding the benefits value to the new customer account; and
sending a notification to a customer associated with the new customer account.

16. The method of claim 13, wherein the notification is at least one of: an e-mail, a physical note, a phone call, and a new customer card.

17. The method of claim 11, further comprising:
periodically retrieving repair orders from each of a plurality of members.

18. The method of claim 11, further comprising:
determining whether the repair order includes a predetermined code; and
when the predetermined code appears in the repair order, discarding the repair order.

19. The method of claim 13, further comprising:
providing an indication to the first member, based on information in a stored customer account relating to one or more previously-declined services offered by the first member to the customer associated with the stored customer account.

20. The method of claim 13, further comprising:
adjusting profit attributable to one or more prepaid services sold by the first member to a customer based on a change in pricing of the one or more prepaid services after sale of the one or more prepaid services.

21. The method of claim 13, wherein the stored benefits value comprises a pre-paid value intended for use in purchasing one or more prepaid goods or services, and wherein the pre-paid value represents a prepayment of funds stored in a financial account owned by the first member.
